(19) United States
(12) Patent Application Publication
(10) Pub. No.: US 2008/0190033 A1
(43) Pub. Date: Aug. 14, 2008

(54) Motor Vehicle Door Arrangement

(76) Inventors: Harald Kruger, Erlangen (DE); Olaf Kriese, Lautertal (DE); Markus Schultz, Nurnberg (DE)

Correspondence Address: CHRISTIE, PARKER & HALE, LLP, PO BOX 7068, PASADENA, CA, 91109-7068, US

(21) Appl. No.: 11/884,176

(22) PCT Filed: Jan. 27, 2006
(86) PCT No.: PCT/DE06/00139

§ 371 Date: Apr. 14, 2008

(30) Foreign Application Priority Data
Feb. 10, 2005 (DE) 10 2005 006 630.5

(51) Int. Cl. B60J 5/04; E06B 7/16

(52) U.S. Cl. 49/489.1; 49/502

(57) ABSTRACT

A motor vehicle door arrangement with an inside door subassembly which separates a dry space from a wet space and outside space of the door arrangement includes a window pane, a window lifter with an adjustment device for setting the position of the window pane and a seal, which is assigned to the inside door subassembly, for sealing off the dry space with respect to the wet space and the outside space. The adjustment device includes a drive and an adjustment mechanism, which is connected downstream of the drive, in order to transmit the driving torque produced by the drive to the window pane. The entire adjustment mechanism of the window lifter is arranged in the dry space.

The invention relates to a motor vehicle door arrangement according to the precharacterizing clause of patent claim 1.

A motor vehicle door arrangement of this type comprises an inside door subassembly which separates a wet space from a dry space of the door arrangement, and a window pane which is mounted on the door arrangement in an adjustable manner in order to open and close a window opening, in particular in a vertically adjustable manner by displacement or pivoting of the window pane in the window pane plane. For this purpose, the window pane is assigned a window lifter adjustment device which has a drive in the form of a driving motor or a crank, usually arranged in the dry space of the door arrangement, and an adjustment mechanism, arranged downstream of the drive, for transmitting the torque produced by the drive to the window pane.

The inside door subassembly is generally formed by an inside door skin and a window frame bounding the window pane opening, with it being possible for the inside door skin to comprise, for example, a single-part inside door wall or a combination of an inner door frame with a unit carrier which is arranged thereon and on which different door components are preassembled. After installation of a motor vehicle door in a motor vehicle, the inside door skin is adjacent firstly (by means of an inner surface) to the vehicle interior of the motor vehicle and is covered there by an inside door molding and, secondly (by means of its outer surface) to the “door channel” or door box which is bounded towards the outside space of the vehicle by an outside door skin which forms an outer design surface (painted in the color of the particular motor vehicle) of the motor vehicle door. The door channel or door box bounded on one side by the inside door skin and on the other side by the outside door skin is referred to as the wet space into which moisture from the outside of the motor vehicle can penetrate. By contrast, those regions of the motor vehicle door which is situated in front of the inner surface of the inside door skin, i.e. in particular the space situated between the inside door skin and the associated inside door molding, form the dry space. For this purpose, the inside door skin is assigned a seal via which it bears against further components of the motor vehicle door arrangement in such a manner that no moisture can penetrate from the wet space into the dry space located in front of the inner surface of the inside door skin.

In addition, the dry space of the vehicle door also includes those regions which are located above the inside door skin or above the “door breast”, which upwardly bounds the above-described door channel or door box, in front of the inner surface of the motor vehicle door or of the window pane thereof, which surface faces the vehicle interior. For this purpose, the window pane is assigned a “window pane seal” which runs in the window frame defining the window opening and against which the lateral edges of the window pane bear in an encircling manner when the window pane is in its upper closed position, and therefore the dry space is also sealed off in the region of the window pane from the outside space outside a motor vehicle.

If the window pane is lowered from an upper closed position into a lower position in order to (partially) open up the window opening, the window pane is lowered into the motor vehicle door wet space which is located between the inside door skin and the outside door skin and is referred to as the door channel or door box. This means that the adjustment mechanism, via which the adjustment force produced by the drive or the adjustment torque produced by the drive in order to adjust the window pane is introduced into the latter, is located at least partially in the door channel or door box, and therefore a connection to the window pane to be adjusted there can take place there.

On the other hand, the drive assigned to the adjustment mechanism is usually arranged in the dry space, in the case of an electric motor drive in particular in order to protect the driving components from moisture and wetness and, in the case of a manual drive, with respect to being able to easily reach the associated operating elements (crank) from the vehicle interior.

The invention is based on the problem of improving a motor vehicle door arrangement of the type mentioned at the beginning with respect to the arrangement of the window lifter.

This problem is solved according to the invention by the creation of a motor vehicle door arrangement with the features of patent claim 1.

According thereto, the adjustment mechanism of the window lifter is arranged—as viewed from the dry space—in the dry space completely on this side of the seal which seals off the dry space from the wet space and outside space of the motor vehicle door.

By this means, the components of the window lifter are exposed to a lesser amount of environmental influences and, in addition, can be combined in a simple manner with the associated electric motor and manual drive to form a subassembly on the dry-space side. Sealing profiles suitable for this are explained in more detail below.

The adjustment mechanism is coupled within the dry space to a force application region provided on the window pane, for example in the form of a driver connected to the window pane, via which the adjustment mechanism acts, for example with a component, on that (inner) surface of the window pane which faces the dry space (vehicle interior).

In order, in this connection, to ensure that the adjustment mechanism, including the components coupled to the force application region of the window pane, are always located in the dry space, a suitable profile of the sealing section is to be provided which serves to seal off the door channel in the door breast region (i.e. at the upper end of the door channel) on that side of the window pane which faces the vehicle interior. This sealing section runs on the inside door skin transversely with respect to the adjustment direction of the window pane (in the longitudinal direction of the vehicle) in such a manner that the window pane bears in every adjustment position against that sealing section, and therefore no moisture from the door channel or door box forming a wet space can penetrate the dry space in front of the inner surface of the window pane.

According to the present invention, the sealing section running between inside door panel and window pane in the region of the door breast is lowered at least in some sections in such a manner that the respective (if appropriate position-dependent) force application region, at which the adjustment mechanism of the window lifter acts on the window pane, is located above that sealing section in every adjustment position of the window pane, and therefore those components of the adjustment mechanism which act on the force application region of the window pane are separated, according to the invention, in a moisture proof manner from the wet space by that sealing section. It is therefore not required that the adjustment mechanism extends into the wet space of the motor vehicle door arrangement in order to act on the window pane to be adjusted and to transmit the adjustment force produced by the drive to the window pane. The adjustment mechanism (without the force application region which is to be assigned to the window pane, is connected rigidly thereto or is integrally formed thereon) can therefore be arranged in its entirety in the dry space although the window pane to be adjusted is guided into the wet space formed by the door channel or door box as it is being lowered from the closed position.

According to an embodiment of the invention, the adjustment mechanism together with the drive is arranged on the inside door skin surface on the dry-space side, and the inside door skin has an opening through which at least one component of the adjustment mechanism reaches in order to act on the force application region of the window pane. That component of the adjustment mechanism can be designed, for example, as a gear element in the form of a pinion which interacts with a force application region, which is stretched out in the adjustment direction of the window pane, in the form of a rack. In this case, the sealing section stretched out on the door breast between the inner surface of the window pane and the inside door skin runs in such a manner that the opening lies in the dry space above that sealing section. The uppermost subregion of the door channel or door box that is situated between the inner surface of the window pane and the outer surface of the inside door skin and at the same time above said breast-side sealing section therefore forms part of the dry space which is covered against moisture from the remaining regions of the door channel by means of the sealing section.

A further sealing region extends along the window frame, to be precise in particular with a U-shaped cross section, and therefore the window pane to be adjusted can be guided on the edges in said sealing region, with the latter bearing both against that surface of the window pane which faces the dry space and also against that surface of the window pane which faces away from the dry space (and therefore faces the outside space of a motor vehicle) and thereby ensuring that the dry space (vehicle interior) is reliably sealed off from the outside space.

According to a further exemplary embodiment of the invention, the adjustment mechanism of the window lifter acts on the window pane next to at least one frame section of the window frame, which frame section is stretched out in the adjustment direction of the window pane, to be precise in such a manner that the force application region is moved along said frame section during an adjustment movement of the window pane. The force application region may be, for example, a driver on which the adjustment mechanism acts with a component located on this side of the sealing region, as viewed from the dry space. The force application region formed on the window pane, for example in the form of a driver, is preferably located next to a lateral edge of the window pane and at the same time in the region of the upper end of the window pane—based on the door arrangement when installed in a motor vehicle.

The force application region is protected against the penetration of moisture from the outside space by the sealing region guided along the window frame—at least when the window pane is closed—and at the same time is protected from moisture or wetness originating from the door channel or door box (wet space of the vehicle door) by the sealing section running along the door breast between the inner surface of the window pane and the inside door skin. For this purpose, said sealing section in turn is to be arranged in such a manner that it lies below the current force application region of the window pane in every setting position of the window pane. This embodiment is facilitated by the force application region being provided at the upper end of the window pane, which end penetrates, albeit slightly, into the door box or door channel even when the window pane is fully lowered.

In this embodiment of the invention, the window lifter can advantageously be designed as a tensioning means window lifter which acts on the window pane via at least one tensioning means which is coupled to the drive. The tensioning means can be a flexible tensioning means, for example in the form of a cable, which is guided along the adjustment direction by a deflecting element. On the other hand, in order to couple the window pane to the drive, this can be made of a rising cable which can exert compressive forces in addition to tensile forces. Other flexible force transmission elements for coupling the drive to the window pane, such as, for example, a toothed belt or an articulated chain, may also be used for the force transmission.

Furthermore, a thickened portion, an angled end section or another form-fitting region can be provided on a lateral edge of the window pane, in particular in the case of a pane made of plastic, via which the window pane can be supported on an associated lateral frame section of the window frame in such a manner that a tilting of the window pane about a horizontal transverse axis of the vehicle running transversely with respect to the door or window pane plane is prevented.

Further details and advantages of the invention will become clear in the description below of exemplary embodiments with reference to the figures, in which:

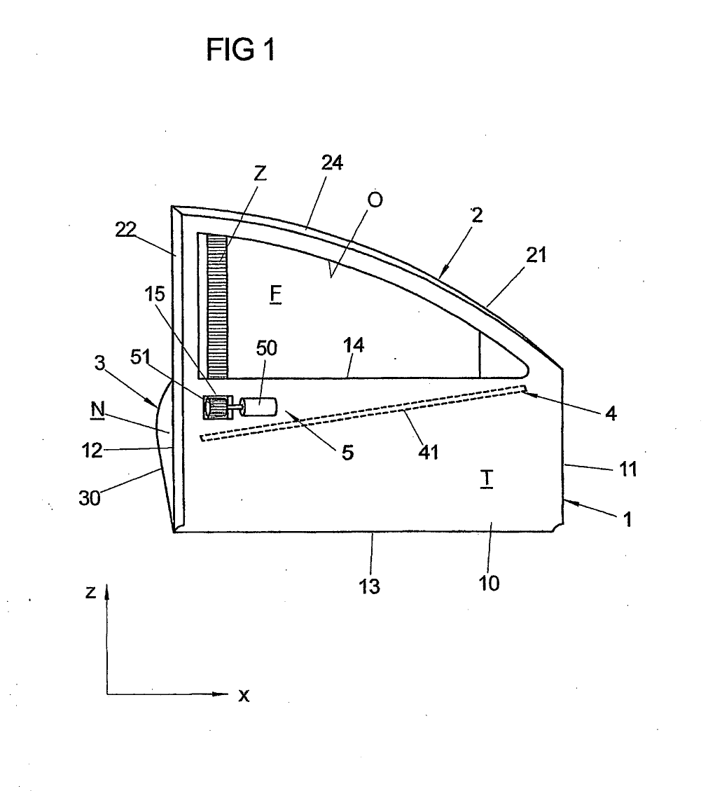

FIG. 1 shows a perspective side view of a motor vehicle door with a window lifter, arranged in the dry space, for adjusting a displaceably mounted window pane;

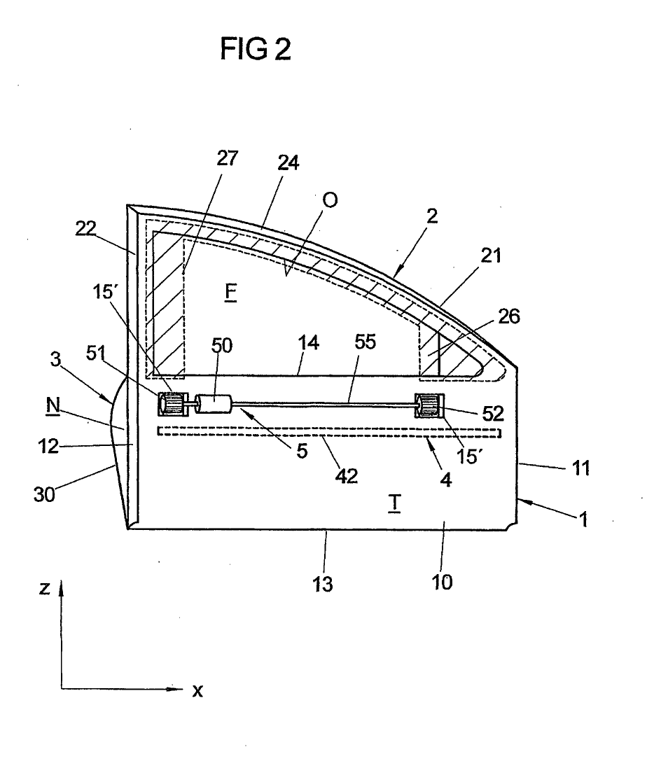

FIG. 2 shows a second exemplary embodiment of a motor vehicle door with a window lifter, arranged in the dry space, for adjusting a displaceably mounted window pane;

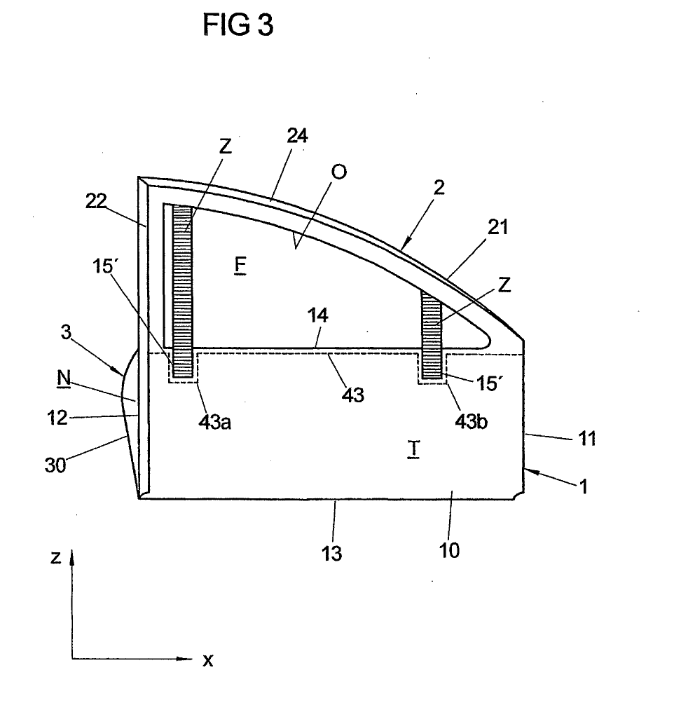

FIG. 3 shows a modification of the motor vehicle door from FIG. 2 with respect to the design of the door breast;

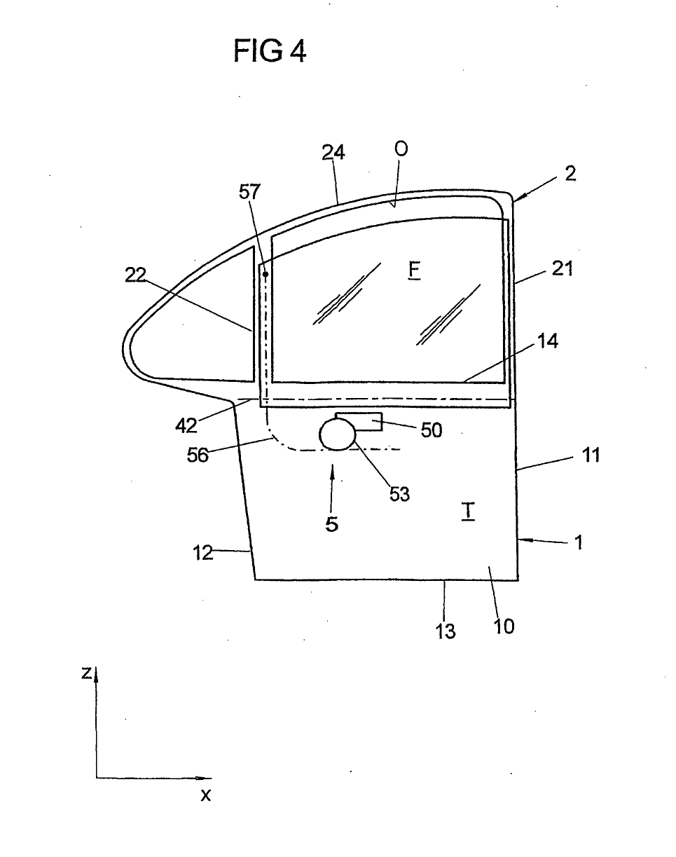

FIG. 4 shows a third exemplary embodiment of a motor vehicle door with a window lifter, arranged in the dry space, for adjusting a displaceably mounted window pane;

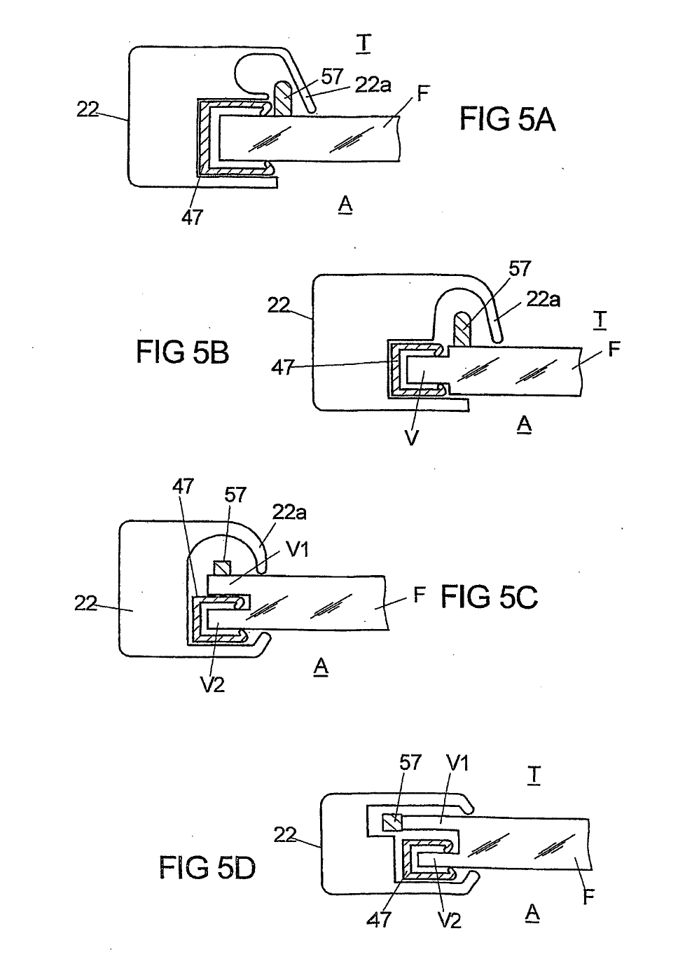

FIGS. 5a-5d show four different cross-sectional illustrations of a possible design of a lateral frame section of the motor vehicle door from FIG. 4;

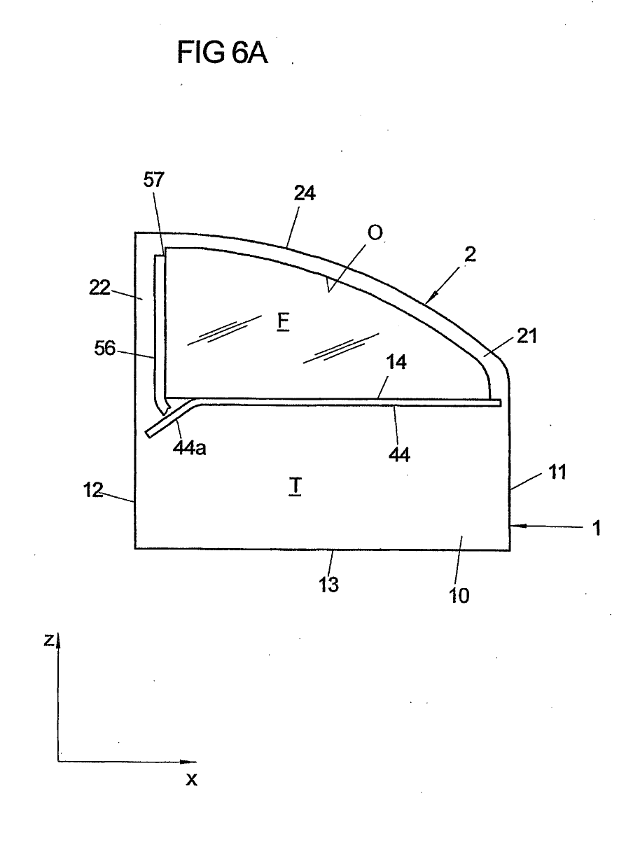

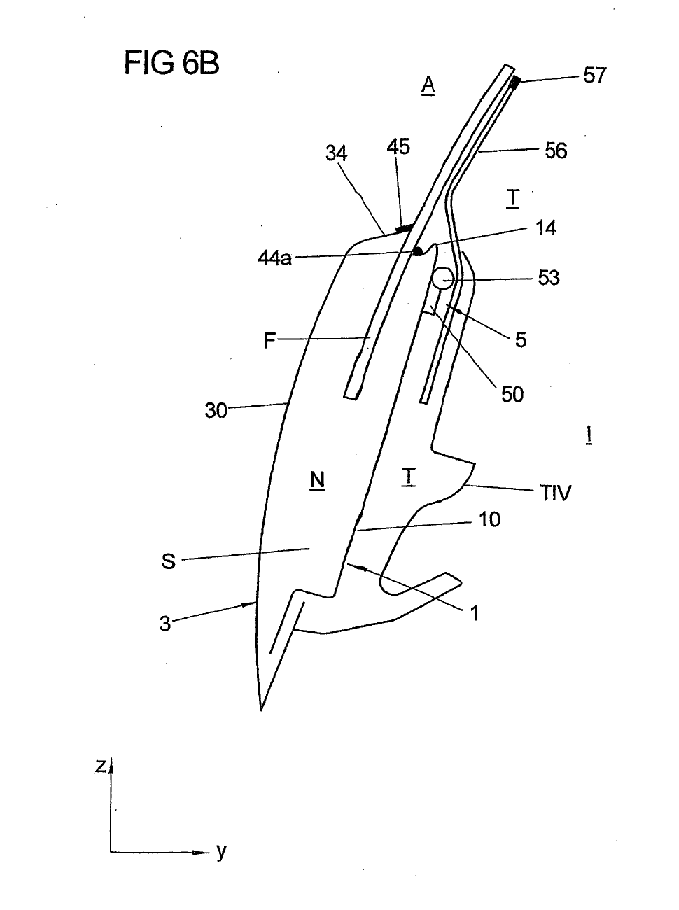

FIGS. 6a and 6b show a fourth exemplary embodiment of a motor vehicle door with a window lifter, arranged in the dry space, for adjusting a displaceably mounted window pane;

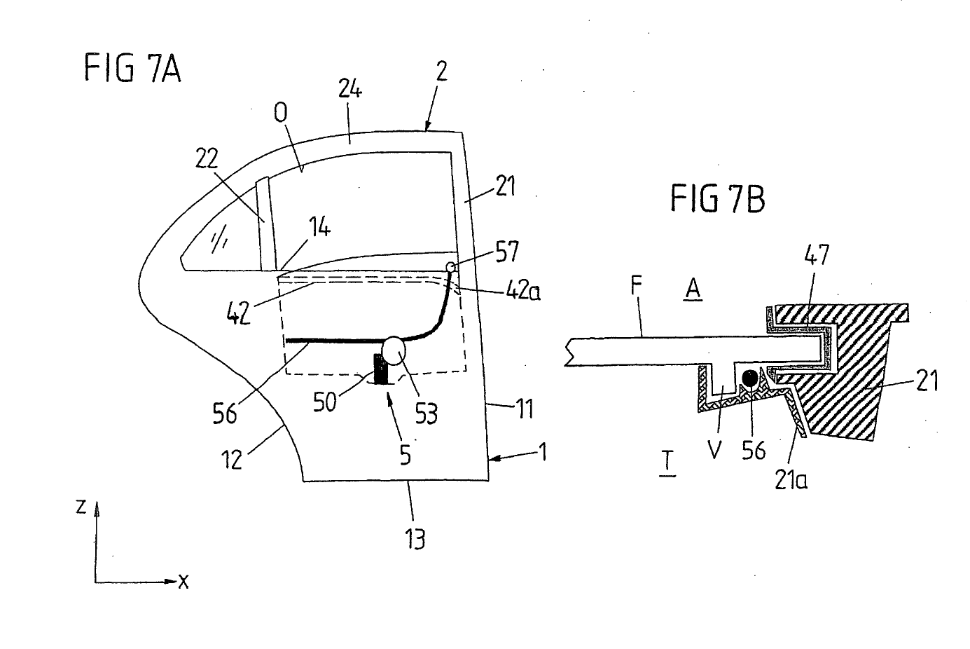

FIG. 7a shows a fifth exemplary embodiment of a motor vehicle door with a window lifter, arranged in the dry space, for adjusting a displaceably mounted window pane;

FIG. 7b shows a cross section through the motor vehicle door from FIG. 7a in the region of a lateral frame section of the window frame;

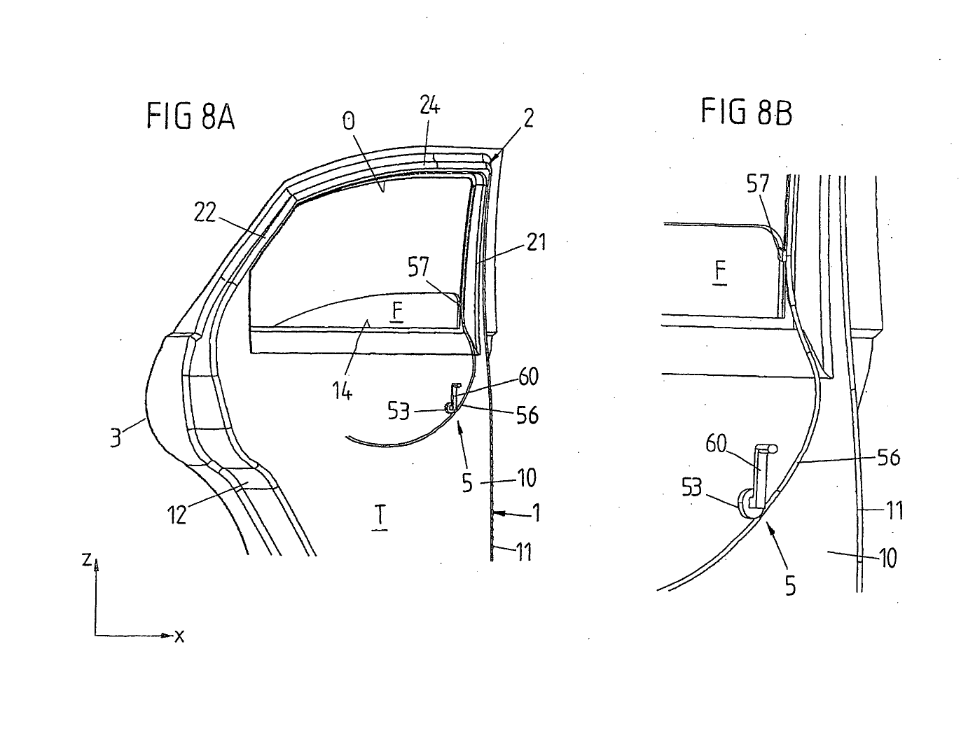

FIG. 8a shows a perspective illustration of a motor vehicle door of the type illustrated in FIGS. 7a and 7b;

FIG. 8b shows a detail of the motor vehicle door from FIG. 8a;

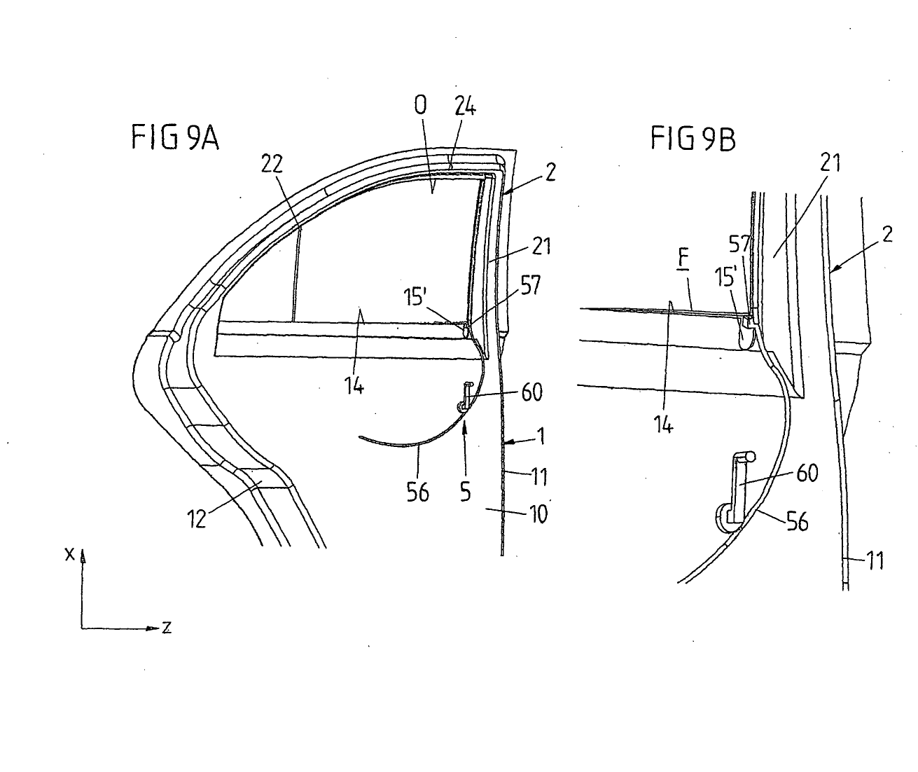

FIG. 9a shows a further perspective illustration of a motor vehicle door of the type illustrated in FIGS. 7a and 7b;

FIG. 9b shows a detail of the motor vehicle door from FIG. 9a;

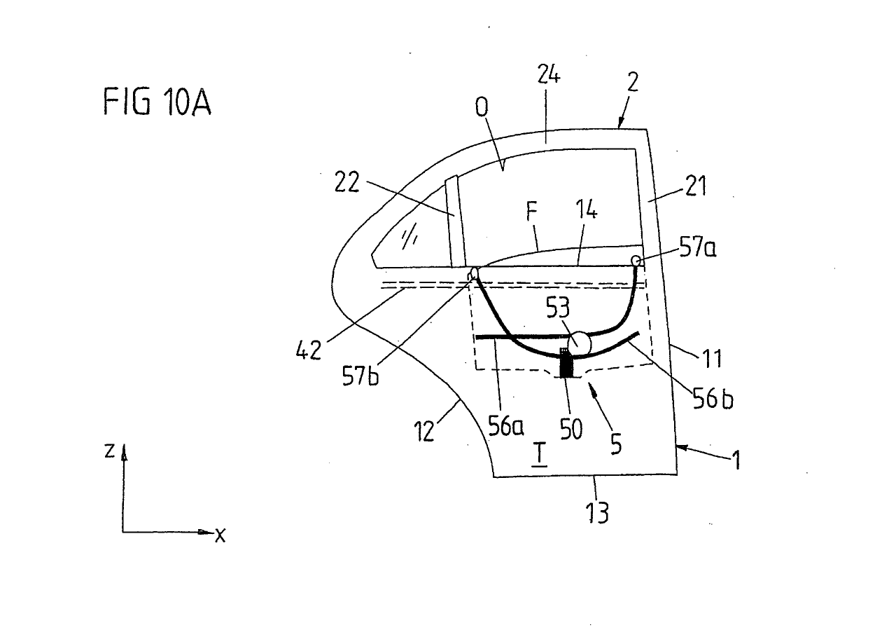

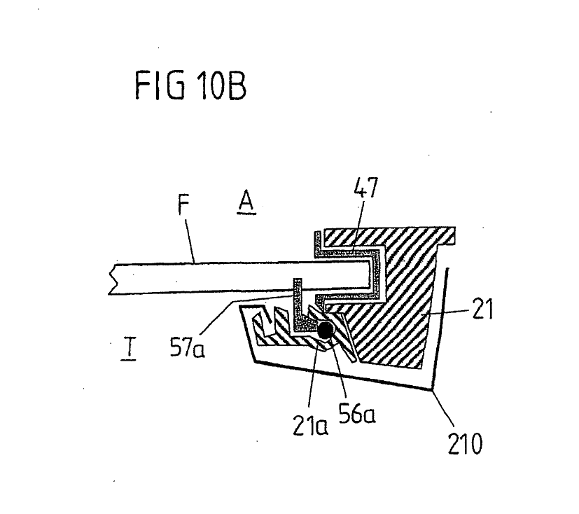

FIG. 10a shows a sixth exemplary embodiment of a motor vehicle door with a window lifter, arranged in the dry space, for adjusting a displaceably mounted window pane;

FIG. 10b shows a cross section through the motor vehicle door from FIG. 10a in the region of a lateral frame section of the window frame;

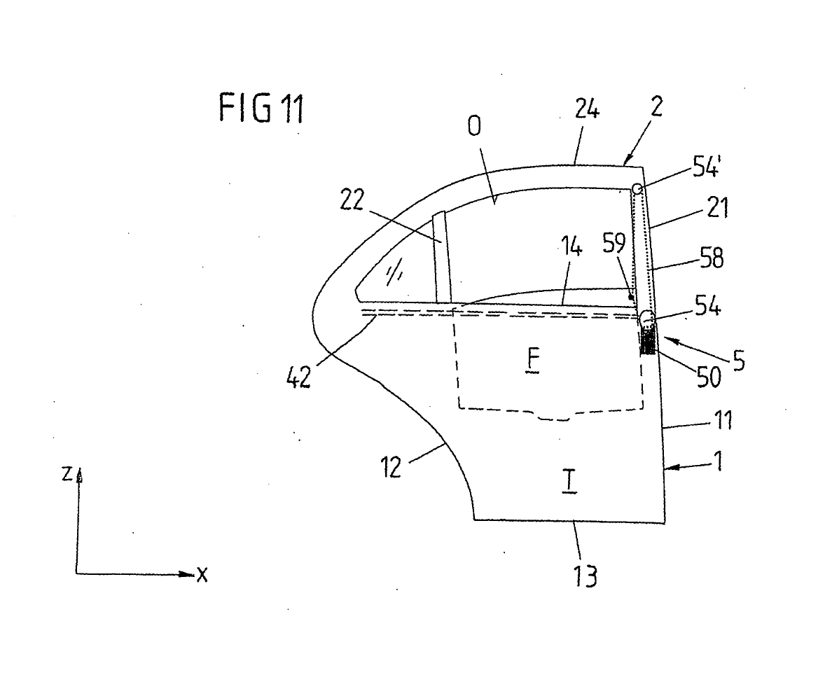

FIG. 11 shows a seventh exemplary embodiment of a motor vehicle door with a window lifter, arranged in the dry space, for adjusting a displaceably mounted window pane.

FIG. 1 shows, in a perspective side view, a motor vehicle door (front door), comprising an inside door subassembly 1, 2 and an outside door skin 3.

The inside door subassembly 1 comprises an inside door skin 1 which forms an inside door wall 10 and—based on the state in which it is installed in a motor vehicle—has two edge sections 11, 12, which are spaced apart from each other in the longitudinal direction x of the vehicle and are stretched out vertically, and a lower edge 13 and an upper edge 14 which forms a door breast, the lower edge 13 and upper edge 14 of the inside door skin 1 being spaced apart from each other along the vertical vehicle axis z.

The inside door skin 1 is upwardly adjoined by a window frame 2 which defines a window opening O and comprises a front lateral frame section 21, a rear lateral frame section 22 spaced apart therefrom in the longitudinal direction of the vehicle, and an upper frame section 24. The window opening O bounded by the window frame 2 and the door breast 14 is closed by a window pane F which can be lowered by means of a window lifter 5 in order to open up the window opening O. A door channel or door box which lies between the inside door skin 1 and an outside door skin 3, which forms an outer design surface 30 of the motor vehicle door, is used to receive the lowered window pane. Said door channel or door box, which forms the wet space N of the motor vehicle door, is therefore bounded on one side by the outer surface of the inside door skin 1 (facing the outside door skin 3) and on the other side by the inner surface of the outside door skin 3 (facing the inside door skin 1).

In order to lower the window pane F to open up the window opening O, use is made of a window lifter 5 which has a motor drive 50 and, as adjustment mechanism, a gear element 51 which is arranged downstream of the motor drive 50, is in the form of a pinion and interacts with a gear element which is stretched out along the window pane F—along the adjustment direction z of the window pane F, is arranged fixedly on the window pane F and is in the form of a rack Z. The latter may be fitted rigidly to the window pane as a separate subassembly or, in particular in the case of a window pane made of plastic, can be integrally formed as a single piece on the latter.

The motor drive 50 and the pinion 51 which is arranged downstream and is driven thereby form an adjustment device of the window lifter 5, which device is arranged on the dry-space side T of the inside door wall 1, i.e. on the inner surface of the inside door skin 1 which faces away from the outside door skin 3 and faces the vehicle interior—based on the state in which it is installed in a motor vehicle.

So that the pinion 51, which is arranged in the dry space T on the inner surface of the inside door skin 1, can interact with the rack Z, which runs in the vertical direction on a lateral edge of the window pane F, a cutout 15 is provided in the inside door skin 1 in the form of a passage opening through which the pinion 51 protrudes into the upper end region of the door channel or door box where it interacts with the rack Z on the window-pane side. Depending on the setting position of the window pane F, a respectively different position of the rack Z forms the current (positionally dependent) force application region which is on the window-pane side and on which the pinion 51 engages in order to introduce the adjustment force produced by the motor drive 50.

In order to seal off the dry space, in which the adjustment device 50, 51 of the window lifter 5 is arranged, from the wet space formed in the door channel or door box, a sealing section 41 is provided which extends in the region of the door breast, i.e. along the upper edge 14 of the inside door skin 1 between the inside door skin 1 and the window pane F and firstly is fixed to the inside door skin 1 and secondly bears in a sealing manner against the inner surface of the window pane F, which surface faces the inside door skin 1 or the vehicle interior. Said sealing section 41 can be arranged (e.g. placed), for example, on an obliquely extending inner channel reinforcement (i.e. an obliquely extending reinforcement of the inside door skin 1) or on an obliquely sloping-down inner breast line of the motor vehicle door.

In the case of known motor vehicle doors, said sealing section runs in the longitudinal direction x of the vehicle directly on the breast-side, upper edge 14 of the inside door skin 1. In the present case, such an arrangement of the sealing section 41 would result in the pinion 51, which reaches through the opening 15 of the inside door skin 1, engaging in the wet space N of the motor vehicle door.

In the present case, in order to completely arrange the adjustment device 50, 51 of the window lifter 5.in the dry space, the sealing section 41, which is provided for sealing off the dry space or vehicle interior from the wet space N, runs at a slight inclination with respect to the longitudinal direction x of the vehicle, to be precise in such a manner that the opening 15 of the inside door skin 1 and the pinion 51 which reaches through said opening are located—as viewed along the vertical vehicle axis z—above said sealing section 41. The effect achieved by the slightly inclined profile of the sealing section 41 below the upper edge 14 of the inside door skin 1, and spaced apart from said edge along the vertical vehicle axis z, is that the subregion of the door channel or door box which is positioned above said sealing section 41 and is bounded on the one side by the inner surface of the window pane F and on the other side by the outer surface of the inside door skin 1 is not included in the wet space N but rather forms part of the dry space which is sealed off from the wet space N. The adjustment device 50, 51 of the window lifter 5, i.e. those parts which transmit the adjusting force of the motor drive 50 to the window pane F and, for this purpose, act on a rack Z, which is located on the window pane F and serves as the force application region, therefore also lies completely in the dry space T of the motor vehicle door, i.e. outside the wet space which is formed between the inside door skin 1 and the outside door skin 3 and is upwardly bounded by the sealing section 41 which runs in an inclined manner.

FIG. 2 shows a modification of the arrangement from FIG. 1, in which the motor drive 50 of the window lifter 5 uses a drive shaft 55, which is stretched out in the longitudinal direction x of the vehicle, to drive two pinions 51, 52 which are spaced apart from each other in the longitudinal direction x of the vehicle and are respectively assigned to one of the two lateral edges of the window pane F to be adjusted. Accordingly, a respective rack Z (as illustrated in FIG. 1) is to be provided here on both lateral edges of the window pane F, said racks interacting with in each case one of the pinions 51, 52 driven by the motor drive 50. In the present case, the racks are covered towards the vehicle interior by a respective panel section 26, 27 of a panel.

A further difference over the exemplary embodiment according to FIG. 1 is that the two cutouts 15′ of the inside door skin 1, through which one of the two pinions 51, 52 is in engagement in each case with the respectively associated rack Z on the window-pane side, are not designed as passage openings which are enclosed on all sides but rather are directly adjacent to the upper edge 14 of the inside door skin 1.

Finally, the sealing section 42, which seals off the dry space from the wet space, does not run, according to FIG. 2, at an inclination but rather—based on the state in which it is installed in a motor vehicle—horizontally along the longitudinal axis x of the vehicle. However, the sealing section is lowered along the vertical vehicle axis z with respect to the upper edge 14 of the inside door skin 1 in such a manner that the two pinions 51, 52 and the drive shaft 55 of the adjustment device 50, 51, 52, 55 of the window lifter 5 lie above said sealing section 42 and therefore outside the wet space N, which is upwardly bound by the sealing section 42 and is formed in the door channel or door box. All of the components of the adjustment device 50, 51, 52, 55 of the window lifter 5 are therefore located in the dry space T of the motor vehicle door outside the wet space N.

This does not apply to the two racks Z, which are arranged on the window pane F to be adjusted and which are moved rigidly together with the window pane F during an adjustment movement thereof. These are fixed components of the window pane F which form a force application region of the window pane F, on which the adjustment device 50, 51, 52, 55 acts by means of the pinions 51, 52, which are provided for this purpose, in order to transmit the adjustment force produced by the motor drive 50. As components of the window pane F, said racks Z are moved during the lowering of the window pane into the door channel or door box at least in some sections together therewith into the wet space N located below the sealing section 42. However, it is of importance that at least one section of the racks Z is always located in the dry space above said sealing section 42—even when the window pane is completely lowered into the door box or door channel, and therefore, in each position of the window pane F to be adjusted, the racks Z define a force application region which is located in the dry space and on which the adjustment device 50, 51, 52, 55 can act by means of its pinions 51, 52 in the dry space.

The pinions 51, 52 may also act directly in the region of the lateral frame sections 21, 22 of the window frame 2 on a respective rack provided on the window pane F. The requirement for a separate covering of the racks and of the pinions by additional panel parts is then no longer necessary.

FIG. 3 shows a modification of the motor vehicle door from FIG. 2—but without the window lifter being illustrated, with the sealing section 43, which is provided for sealing off the dry space T from the wet space N, running in some regions directly along the upper edge 14 of the inside door skin 1 and only in the region of the two cutouts 15′ being lowered in a respective subsection 43a and 43b in such a manner that it is guided below the two cutouts 15′.

FIG. 4 shows a rear door of a motor vehicle from the dry-space side, which rear door, corresponding to the motor vehicle doors illustrated in FIGS. 1 to 3, has an inside door subassembly 1, 2, comprising an inside door skin 1 and a window frame 2. In the present case, in order to adjust the window pane F which, in its upper closed position, closes a window pane opening O which is defined by the window frame 2 and the upper, breast-side edge 14 of the inside door skin 1, use is made of a window lifter 5, the adjustment device 50, 53, 56 of which comprises a rising cable 56 which is driven by a motor drive 50 and a gear 53 connected downstream of the motor drive 50. At its end which faces away from the motor drive 50 and the downstream gear 53, the rising cable 56 is connected to a driver 57 which is arranged on the window pane F and is fastened thereto. By this means, the rising cable 56 couples the motor drive 50 to the window pane F to be adjusted. The driver 57 is located on a lateral edge of the window pane F, and therefore it is guided on a lateral frame section 22 of the window frame 2, which frame section is stretched out in the adjustment direction z of the window pane. Further details in this respect will be explained below with reference to FIGS. 5a to 5d. The rising cable 56 is preferably guided—in the manner of known “tubular window lifters”—in a slotted tube, the longitudinal slot of which can serve at the same time as the guide slot for the driver 57.

The driver 57 is furthermore arranged in the region of the upper window pane edge of the window pane F in such a manner that, in every position of the window pane F, i.e. even in the completely lowered position in which the window pane F is arranged in the door channel or door box, it is located above the sealing section 42 which runs parallel to the breast line (i.e. to the upper edge 14 of the inside door skin 1).

The rising cable 56 via which the motor drive 50 is coupled to the window pane F to be adjusted is designed in such a manner that it can exert both tensile forces on the window pane F, in order to lower the latter into the door channel or door box, and can exert compressive forces on the window pane F, in order to displace the latter into its upper closed position.

Since the rising cable 56 acts on the window pane F or on the driver 57 thereof in the region of a lateral frame section 22 of the window frame 2, it furthermore has to be ensured, for an arrangement in the dry space, that, at least when the window pane F is closed, i.e. when the window pane F is in the upper closed position and completely closes the window opening O, the window frame 2 is sealed off from the outside space (space outside the motor vehicle), the seal preventing moisture from penetrating from the outside space into the motor vehicle dry space which is situated in front of the window pane F. It is therefore to be ensured that, when the window pane F is closed, the vehicle interior and therefore, in particular, also the adjustment mechanism 53, 56, 57 of the window lifter F form part of the dry space which is both sealed off from the wet space located in the door channel or door box and from the outside space outside the vehicle against the penetration of moisture and wetness. By contrast, when the window pane F is (partially) open, such sealing is not possible, of course, because the partially exposed window pane opening O then permits moisture to penetrate from the outside space into the interior of the motor vehicle.

FIGS. 5a to 5d illustrate different variants of the sealing off of the dry space T from the outside space A in the region of the window frame, in particular on a lateral frame section 22. An identical sealing off from the outside space can be provided on the other lateral frame section 21 of the window frame 2.

As revealed in FIG. 5a, the lateral frame section 22 forms a window pane guide in which the window pane F is guided in a longitudinally displaceable manner by means of a lateral edge. A sealing region 47 which is essentially U-shaped in cross section extends in said window pane guide formed on the frame section 22, the sealing region bearing with angled end sections of the two limbs of the U on the one hand against the inner surface of the window pane F on the dry-space side and on the other hand against the outer surface of the window pane F on the outside-space side. The sealing region 47 is pressed into the guide channel, formed on the window frame 22, for the lateral edge of the window pane F in such a manner that no moisture can pass from the outside space A into the dry space T through the guide channel of the frame section 22 when the window pane F is in its upper closed position and the sealing region 47 thus bears along its entire length, i.e. as far as the upper frame section 24, cf. FIG. 4, against the window pane F.

The driver 57 is fixed on the inner surface of the window pane F on the dry-space side or, in the event of a plastic pane, is possibly integrally formed on the latter and therefore sealed off from the outside space A by means of the sealing region 47 which serves as a window pane seal and lies on the other side of the driver 57, as viewed from the dry space T. The driver 57 is covered by an angled section 22a of the window frame 22, which section can be integrally formed as a single piece on the latter or can be fastened thereto as a separate part.

FIG. 5b shows a modification of the exemplary embodiment from FIG. 5a, in which the window pane F is guided by a projection V, which protrudes in the window pane plane from its lateral edge, in the cross-sectionally U-shaped sealing region 47 which, in turn, is arranged in the guide channel formed on the frame section 22. In this case, the sealing region 47 bears, on the one hand, against that surface of said projection V of the window pane F that is on the outside-space side and, on the other hand, against that surface of said projection V of the window pane F that is on the dry-space side, and the driver 57 is in turn located, as viewed from the dry space T, on this side of the sealing region 47 serving as the window pane seal. Said sealing region is therefore located completely between the outside space A and the driver 57, and therefore the latter, which is completely sealed off from the outside space A, is located in the dry space T. The same applies to the mechanical components, acting on the driver 57, of the window lifter 5, such as, for example, the rising cable 56, cf. FIG. 4.

FIG. 5c illustrates a modification of the exemplary embodiment from FIG. 5b, in which two projections V1, V2 are provided on that lateral edge of the window pane F which is guided in the frame section 22, said projections protruding in the window pane plane and a cutout being formed between them, into which one limb of the cross-sectionally U-shaped sealing region 47 serving as a window pane seal engages.

FIG. 5d in turn shows a modification of the exemplary embodiment from FIG. 5c, with, according to FIG. 5d, the driver being arranged on an interior-side projection V1 of the two projections V1, V2 protruding in the window pane plane from a lateral edge of the window pane F. The sealing region 47 engages, as in the exemplary embodiment illustrated in FIG. 5c, around the other projection V2 on the outside-space side, and therefore, in turn, the sealing region 47 is completely located between the outside space A and the driver 57 which, accordingly, sealed off from the outside space A, is located on this side of the sealing region in the dry space T.

An overall view of FIGS. 5a to 5d with FIG. 4 reveals that the adjustment device of the window lifter 5, comprising a motor drive 50 and an adjustment mechanism 53, 56 arranged downstream, is completely located in the dry space T by, firstly, being sealed off from the outside space A in the region of the window pane F by means of a window pane seal 47 and, secondly, being sealed off from the wet space formed in the door channel in the region of the inside door skin 1 by means of a breast-side sealing section 42. Said adjustment mechanism is therefore located, as viewed from the dry space T, completely on this side of the sealing arrangement 42, 47, i.e. both of the breast-side sealing section 42 and of the frame-side sealing region 47.

FIGS. 6a and 6b illustrate a front door for a motor vehicle with a window lifter 5 which is arranged in the dry space T and has a rising cable 56, the motor drive 50 not being illustrated in the side view according to FIG. 6a but being shown in the cross-sectional illustration according to FIG. 6b.

According to FIGS. 6a and 6b, the motor vehicle door comprises an inside door subassembly 1, 2 with an inside door skin 1 forming an inside door wall 10 and a window frame 2 which upwardly adjoins said inside door skin along the vertical vehicle axis and defines a window pane opening O which can be closed by a window pane F.

An outside door skin 3 is connected to the inside door skin 1 and forms the outer design surface 30 of the motor vehicle door and—as viewed along the horizontal transverse axis y of the vehicle—is spaced apart from the inside door skin 1 in such a manner that a door channel S is defined between the inside door skin 1 and the outside door skin 3. The window pane F to be adjusted can be pushed, as it is being lowered, into said door channel. The door channel S, which is directly adjacent to the outside space A outside the motor vehicle, forms the “wet space” N of the motor vehicle door, into which moisture and wetness can penetrate from the outside space A.

The door channel S is assigned in the region of its upper end—as viewed along the vertical vehicle axis z—an insertion opening for the window pane F, in the region of which opening two sealing sections 44, 45 extend in the longitudinal direction x of the vehicle. The one sealing section 44 is fixed on the upper edge 14 of the inside door skin 1 and bears at the same time against the inner surface of the window pane F that faces the inside door skin 1. It prevents moisture from penetrating from the wet space into the dry space T of the vehicle door, which, as viewed from the vehicle interior I, is located in front of the inside door skin 1 and the window pane 2.

The other sealing section 45 is fixed to the upper end 34 of the outside door skin 3 and likewise bears against the window pane F, to be precise against the outer surface thereof which faces the outside space A. This is intended to restrict the penetration of moisture and wetness into the door channel S, i.e. into the wet space N.

FIGS. 6a and 6b furthermore reveal that the motor drive 50 and the downstream adjustment gear 53 of the window lifter 5 are arranged below an inside door molding TIV on that surface of the inside door skin 1 which is on the dry-space side. Furthermore, however, the rising cable 56, via which the motor drive 50 is coupled to the window pane F by means of the adjustment gear 53, to be precise by joining the rising cable 56 to a driver 57 provided in the region of the upper window pane edge, is also arranged in the dry space T in every vertical setting of the window pane F. For this purpose, the sealing section 44 which is stretched out along the inner surface of the window pane F and bears against the latter is lowered by an oblique course in the region in which the rising cable 56 extends in such a manner that the driver 57 and therefore also the rising cable 56 connected thereto are located above said sealing section 44 in every setting of the position of the window pane F. That is to say, the sealing section 44 arranged in front of the inner surface of the window pane F runs in a subsection 44a in such a manner that the driver 57, which is provided on the window pane F, and the upper end of the rising cable 56 that is connected thereto do not enter together with the window pane into the wet space N below said sealing section 44.

FIGS. 7a to 10b below show further details for arranging a window lifter 5 with a rising cable 56 on a motor vehicle door.

For corresponding components and subassemblies, the same reference numbers are used in each case as previously in the description of a motor vehicle door with a window lifter having a rising cable with reference to FIGS. 4, 5a to 5d and 6a and 6b.

In the case of the motor vehicle door arrangement, illustrated in FIGS. 7a and 7b, in the form of a rear door, the rising cable 56 of the window lifter 5 is fixed to the window pane F via a driver 57 which is connected to the window pane F or—in the case of a plastic pane—is integrally formed as a single piece on the latter in the region of the upper and front window pane edge—as viewed in the longitudinal direction x of the vehicle.

Again, the sealing section 42 running along the upper edge 14 of the inside door skin 1 between the inside door skin 1 and that surface of the window pane F which faces the inside door skin 1 is lowered in the region of that window pane edge, in the vicinity of which the rising cable 56 is fixed via the driver 57, into a subsection 42a in such a manner that, in each setting of the window pane F, the driver 57 is located in the dry space T above said sealing section 42.

Furthermore, FIG. 7b reveals that the rising cable 56 is arranged with respect to the front frame section 21 of the window frame 2 in such a manner that it is located—as viewed from the dry space T—on this side of the sealing region 47 which serves as the window pane seal and by means of which the vehicle interior (dry space T) is sealed off from the outside space A. A panel 21a connected to the front frame section 21 serves to cover the rising cable. In this case, the window pane F engages by means of a projection V integrally formed on it as a single piece additionally in said panel 21a.

FIGS. 8a and 8b show, in a perspective illustration, a design of a motor vehicle window lifter 5 with a rising cable 56, to which a crank 60 is assigned as the drive, said crank acting on the rising cable 56 via an adjustment gear 53 connected downstream. With regard to the arrangement of the window lifter 5, which is manual here, in the dry space T, reference is made to the corresponding explanations with respect to FIGS. 6a and 6b and 7a and 7b which apply here in the same manner.

FIGS. 9a and 9b illustrate a development of the motor vehicle door arrangement from FIGS. 8a and 8b, in which the inside door skin 1 has, in the region of its upper end 14, a cutout 15′ into which the driver 57 together with the associated end section of the rising cable 56 can run during lowering of the window pane into its lowermost position. By this means, a particularly deep lowering of the window pane is possible such that the latter, in its lowermost position, no longer visibly protrudes into the window pane opening O. The sealing section (not visible in FIGS. 9a and 9b) which is stretched out in the region of the upper edge 14 of the inside door skin 1 between inside door skin 1 and window pane F is then to be guided in a suitable manner below said cutout 15′, as illustrated, for example, with reference to FIG. 3.

FIGS. 10a and 10b illustrate a rear door with a window lifter 5 which uses a motor drive 50 with adjustment gear 53 arranged downstream to drive two rising cables 56a, 56b which are each in engagement with the adjustment gear 53 and which are connected to the window pane F in the region of its upper edge via respective drivers 57a and 57b. In this case, the one driver 57a is located in the vicinity of the front edge of the window pane F next to the front, vertically stretched-out frame section 21 of the window frame 2, and the other driver 57b is located in the vicinity of the rear lateral edge of the window pane F next to the rear, vertically stretched-out frame section 22. By this means, the window pane F to be adjusted is guided during its adjustment movement in a manner secure against tilting at both lateral edges by means of intersecting rising cables 57a, 57b.

The sealing section 42 which is stretched out in the longitudinal direction x of the vehicle in the region of the upper edge 14 of the inside door skin 1 is in turn arranged in such a manner that both drivers 57a, 57b are located in the dry space T above said sealing section 42 in every setting position of the window pane F.

FIG. 10b shows, in addition, the sealing off of the rising cables (e.g. 56a) from the outside space A on the window frame 2, for example on the front frame section 21, as viewed in the longitudinal direction x of the vehicle. As in the previously described exemplary embodiments, the window pane F is guided by means of its corresponding lateral edge in a guide channel of the associated, lateral frame section 21, in which a longitudinally stretched-out sealing region 47 in the form of a window pane seal is arranged. The rising cable 56a and the driver 57a connected to the window pane F are arranged—as viewed from the dry space T—on this side of the sealing region 47, i.e. in a door region which is sealed off from the outside space A.

The rising cable 56a and the driver 57a are assigned a guide channel in an extension or lumber section arranged on the window frame 21, and said unit is in turn covered by an outer covering panel 210.

It is clear with reference to FIG. 11 that the arrangements, explained with reference to FIGS. 4 to 10b, of a motor vehicle window lifter with rising cable in the dry space of a motor vehicle door can also be directly transferred to a window lifter 5 in which a flexible tensioning means 58, for example in the form of a cable, serves as the force transmission means between the drive, for example motor drive 50, and a driver 59 of the window pane F to be adjusted, said tensioning means, in contrast to a rising cable, being able to transmit only tensile forces but not compressive forces. The tensioning means 58 is guided by means of a cable drum of an adjustment gear 54 and at least one deflection element 54′, for example in the form of a deflection roller, in the adjustment direction z of the window pane to be adjusted, to be precise continuously in the dry space T of the corresponding motor vehicle door. For this purpose, firstly, the motor drive 50 together with the adjustment gear 54 arranged downstream is arranged on that surface of the inside door skin 1 which is on the dry-space side, and therefore the coupling of the tensioning means 58 to the motor drive 50 also takes place there via the adjustment gear 54 which has a cable drum. Furthermore, it is ensured that the driver 59, via which the tensioning means 58 acts on the window pane F, is arranged in the region of the upper edge of the window pane F in such a manner that, in every setting position of the window pane F, the driver 59 is located above the sealing section 42 which runs in the region of the upper edge 14 of the inside door skin 1 between inside door skin 1 and window pane F.

With regard to the sealing of those sections of the tensioning means 58 which run along a vertically stretched-out frame section 21 of the window frame 2, reference should be made to the corresponding measures, described in FIGS. 5a to 5d, 7b and 10b, with regard to a tensioning means in the form of a rising cable. Said measures can be applied in the same manner to a flexible tensioning means in the form of a cable or the like.

The improved possibilities for a defined shaping of the window pane edges in a plastic pane that have been illustrated, for example, with reference to FIGS. 5a to 5d can also be used for further purposes. It is thus possible to provide a lateral edge of the window pane F with a thickened portion, an angled edge repositioning means or another form-fitting region which interacts with an associated frame section of the window frame 2 in such a manner that a tilting of the window pane about a horizontal transverse axis y of the vehicle, i.e. about an axis running perpendicularly with respect to the door and window pane plane (xz plane), is opposed. In other words, the form-fitting region integrally formed on the lateral edge of the window pane F is to be designed in such a manner that the window pane F can be supported by said form-fitting region on a frame section of the window frame in such a manner that a tilting of the window pane about the horizontal transverse axis y of the vehicle is prevented.

1-39. (canceled)

40. A motor vehicle door arrangement, comprising:
an inside door subassembly separating a dry space from a wet space and outside;
a window pane being adjustable in order to open and close a window opening;
a window lifter with an adjustment device for setting the position of the window pane, the adjustment device having a drive and an adjustment mechanism, connected downstream of the drive in order to transmit a driving torque produced by the drive to the window pane;
a seal, assigned to the inside door subassembly for sealing off the dry space with respect to the wet space and the outside space, wherein the seal is configured to prevent moisture from entering the dry space when the window pane is closed; and
wherein the entire adjustment mechanism of the window lifter is arranged in the dry space.

41. The motor vehicle door arrangement of claim 40, wherein the adjustment mechanism of the window lifter is coupled in the dry space to the drive.

42. The motor vehicle door arrangement of claim 41, wherein the drive is arranged in the dry space.

43. The motor vehicle door arrangement of claim 40, wherein the adjustment mechanism is coupled in the dry space to the window pane.

44. The motor vehicle door arrangement of claim 43, wherein the adjustment mechanism acts in the dry space on a force application region provided on the window pane.

45. The motor vehicle door arrangement of claim 40, wherein the window pane has a surface facing the dry space and a surface facing away from the dry space.

46. The motor vehicle door arrangement of claim 44, wherein the force application region is arranged on one of a surface of the window pane facing the dry space and on a lateral edge of the window pane.

47. The motor vehicle door arrangement of claim 40, wherein the inside door subassembly comprises an inside door skin having a surface facing the dry space and a surface facing the wet space.

48. The motor vehicle door arrangement of claim 47, wherein the inside door skin together with an outside door skin bounds a door channel forming the wet space.

49. The motor vehicle door arrangement of claim 48, wherein the window pane is configured to be lowered into the door channel with the window lifter.

50. The motor vehicle door arrangement of claim 49, wherein a sealing section protruding into the door channel or being adjacent to the door channel and bearing against the window pane in every setting position thereof is fixed to the inside door skin.

51. The motor vehicle door arrangement of claim 50, wherein the sealing section extends along the window pane transversely with respect to an adjustment direction of the window pane.

52. The motor vehicle door arrangement of claim 51, wherein the adjustment mechanism acts in the dry space on a force application region provided on the window pane, wherein the sealing section is disposed on the inside door skin such that the force application region lies above the sealing section for each setting position of the window pane

53. The motor vehicle door arrangement of claim 47, wherein the drive is arranged upstream of the surface facing the dry space.

54. The motor vehicle door arrangement of claim 47, wherein the adjustment mechanism is arranged upstream of the surface facing the dry space side.

55. The motor vehicle door arrangement of claim 47, wherein the adjustment mechanism reaches through an opening in the inside door skin and acts on the force application region of the window pane behind the opening.

56. The motor vehicle door arrangement of claim 55, wherein the adjustment mechanism acts with a gear element on a gear part stretched out longitudinally in an adjustment direction of the window pane.

57. The motor vehicle door arrangement of claim 56, wherein the gear element is formed by a pinion and the longitudinally stretched-out gear part is formed by a rack.

58. The motor vehicle door arrangement of claim 56, wherein the force application region of the window pane is formed by a subregion of the longitudinally stretched-out gear part with the associated gear element.

59. The motor vehicle door arrangement as claimed in claim 55, wherein the sealing section is configured such that the opening of the inside door skin lies above the sealing section.

60. The motor vehicle door arrangement of claim 50, wherein the adjustment mechanism acts in the dry space on a forece application region provided on the window pane, and wherein the force application region is protected against moisture from the door channel by the sealing section.

61. The motor vehicle door arrangement of claim 40, wherein the inside door subassembly has a window frame bounding the window opening and wherein the window pane is guided on the window frame in an adjustable manner.

62. The motor vehicle door arrangement of claim 61, wherein a sealing region is arranged on the window frame and bears against the window pane and, wherein when the window pane is closed, the sealing region seals off the dry space from the outside space.

63. The motor vehicle door arrangement of claim 62, wherein the sealing region bears both against a surface of the window pane that faces the dry space and against a surface of the window pane that faces away from the dry space.

64. The motor vehicle door arrangement of claim 63, wherein the sealing region is essentially U-shaped in cross section.

65. The motor vehicle door arrangement of claim 62, wherein the sealing region in cross section has free ends angled in the direction of the window pane.

66. The motor vehicle door arrangement of claim 61, wherein the adjustment mechanism acts in the dry space on a force application region provided on the window pane, wherein the adjustment mechanism acts on the window pane in the vicinity of a frame section of the window frame, wherein the frame section is stretched out in the adjustment direction of the window pane, and wherein the force application region is moved along the frame section during an adjustment movement of the window pane.

67. The motor vehicle door arrangement of claim 66, wherein the force application region is formed by a driver fixed on the window pane and is operatively connected to the adjustment mechanism of the window lifter.

68. The motor vehicle door arrangement of claim 62, wherein the force application region of the window pane is separated in a moisture proof manner from the outside space by the sealing region.

69. The motor vehicle door arrangement of claim 68, wherein the force application region is arranged on the window pane in the dry space.

70. The motor vehicle door arrangement of claim 66, wherein the force application region is one of arranged next to the window pane and on a lateral edge of the window pane.

71. The motor vehicle door arrangement of claim 66, wherein the force application region lies in the vicinity of an upper edge of the window pane.

72. The motor vehicle door arrangement of claim 66, wherein in each setting position of the window pane, the force application region lies above the sealing section, the sealing section upwardly bounding the wet space of the door channel.

73. The motor vehicle door arrangement of claim 66, wherein the window lifter has a flexible, longitudinally stretched-out force transmission element for coupling the drive to the window pane.

74. The motor vehicle door arrangement of claim 73, wherein the window lifter is configured as a tensioning window lifter acting on the window pane via at least one tensioner which is coupled to the drive.

75. The motor vehicle door arrangement of claim 74, wherein the tensioner is formed by a rising cable configured to exert tensile and compressive forces on the window pane in order to adjust the window pane.

76. The motor vehicle door arrangement of claim 74, wherein the tensioner is configured to exclusively exert tensile forces in order to adjust the window pane.

77. The motor vehicle door arrangement of claim 40, wherein the window pane has, on a lateral edge section, a form-fitting region protruding from a window pane surface of the window pane in a direction of an associated frame section of the window frame, and wherein the form-fitting region is configured to be supported on said frame section in such a manner that a tilting of the window pane about an axis running perpendicularly to the window pane plane is opposed.

78. The motor vehicle door arrangement of claim 40, wherein the window pane is made of plastic.
